(19) United States
(12) Patent Application Publication
(10) Pub. No.: US 2020/0372412 A1
(43) Pub. Date: Nov. 26, 2020

(54) SYSTEM AND METHODS TO SHARE MACHINE LEARNING FUNCTIONALITY BETWEEN CLOUD AND AN IOT NETWORK

(71) Applicant: SIGNIFY HOLDING B.V., EINDHOVEN (NL)

(72) Inventors: Oscar GARCIA-MORCHON, EINDHOVEN (NL); Abhishek MURTHY, EINDHOVEN (NL)

(21) Appl. No.: 16/959,440

(22) PCT Filed: Dec. 13, 2018
(86) PCT No.: PCT/EP2018/084786

§ 371 Date: Jul. 1, 2020

Related U.S. Application Data
(60) Provisional application No. 62/613,201, filed on Jan. 3, 2018.

(30) Foreign Application Priority Data
Feb. 19, 2018 (EP) 18157320.5

(51) Int. Cl. G06N 20/00; G16Y 40/30; G06K 9/62; H05B 47/19; G06N 3/04

(52) U.S. Cl. CPC G06N 20/00; G16Y 40/30; G06N 3/0481; H05B 47/19; G06K 9/6218

(57) ABSTRACT

A system and methods are provided for using deep learning based on convolutional neural networks (CNN) as applied to Internet of Things (IoT) networks that includes a plurality of sensing nodes and aggregating nodes. Events of interest are detected based on collected data with higher reliability, and the IoT network improves bandwidth usage by dividing processing functionality between the IoT network and a cloud computing network.

### FIELD OF THE INVENTION

The invention relates to a system and methods using deep learning based on convolutional neural networks as applied to IoT networks, more particularly, to detect events based on collected data with higher reliability and to save bandwidth by dividing processing functionality between the IoT network and the cloud.

### BACKGROUND

Smart lighting systems with multiple luminaires and sensors are experiencing a steady growth in the market. Smart lighting systems are a lighting technology designed for energy efficiency. This may include high efficiency fixtures and automated controls that make adjustments based on conditions such as occupancy or daylight availability. Lighting is the deliberate application of light to achieve some aesthetic or practical effect. It includes task lighting, accent lighting, and general lighting.

Such smart lighting systems may use multi-modal sensor inputs, e.g., in the form of occupancy and light measurements, to control the light output of the luminaires and adapt artificial lighting conditions to prevalent environmental conditions. With the spatial granularity that such a sensor deployment comes in the context of lighting systems, there is potential to use sensor data to learn about the operating environment. For example, one such aspect is related to occupancy. There is increased interest in learning about the occupancy environment beyond basic presence. In this regard, occupancy modeling is closely related to building energy efficiency, lighting control, security monitoring, emergency evacuation, and rescue operations. In some applications, occupancy modeling may be used in making automatic decisions, e.g., on HVAC control, etc.

Connecting light sources to a lighting management system also enables a number of advanced features such as: asset management by tracking location and status of light sources, reduced energy consumption by adapting lighting schedules, etc. Such smart lighting systems may also enable other applications such as localization or visible light communication.

There are also other beyond-illumination applications that may be enabled by smart lighting systems. Such applications can run on existing lighting infrastructure and bring additional value. Examples of such other applications include people counting and soil movement monitoring.

People counting applications may be enabled using passive infrared (“PIR”) sensors. Such PIR sensors are traditionally used to reduce energy consumption by switching on lights in those areas that are occupied. PIR sensors are already widely available in the market. There is also the possibility ofusing such PIR sensors for other functions such as people counting in an office, activity monitoring, etc.

Soil movement monitoring applications may be enabled using GPS data. For example, each smart outdoor luminaire may have a GPS sensor so that the luminaire can be automatically located once it is installed. It is known that two GPS sensors, one located in a static area and one located in an area suffering movement, can be used to track with a relatively high accuracy the amount of soil movement. However, it is not known whether there are better algorithms that can be used to produce insights regarding the amount of soil movement.

In this regard, as discussed below, aspects of the present invention utilizing machine and deep learning algorithms may be used to provide improved algorithms.

Machine Learning (ML) is a field of computer science that gives computers the ability to learn without being explicitly programmed. In this regard, machine learning refers to algorithms that allow computers to “learn” out of data adapting the program actions accordingly. Machine learning algorithms are classified into supervised and unsupervised. Unsupervised learning entails drawing conclusions out of datasheets, e.g., by classifying data items into difference classes. No labels are given to the learning algorithm, leaving it on its own to find structure in its input. Unsupervised learning can be a goal in itself (discovering hidden patterns in data) or a means towards an end (feature learning). Supervised algorithms use learnings in past data to apply it to new data. Example inputs and their desired outputs, given by a “teacher”, and the goal is to learn a general rule that maps inputs to outputs. As special cases, the input signal can be only partially available, or restricted to special feedback

Deep learning is a specific type of machine learning algorithms inspired in the way that the brain works. This approach tries to model the way the human brain processes light and sound into vision and hearing. Some successful applications of deep learning are computer vision and speech recognition. Neurons are interconnected triggering an answer depending on the input. Deep learning aims at defining a network of neurons organized in a number of layers so that input data is processed layer by layer so that if the weights between the links are chosen properly the last layer can provide a high level abstraction of the input data.

There are many different alternative designs of deep learning algorithms. For example, Convolutional Neural Networks (CNN) in which the organization pattern of neurons is inspired by the visual cortex. Such CNNs are a special kind of multi-layer neural networks that are trained with a version of the back-propagation algorithm. CNNs use a variation of multilayer perceptron's designed to require minimal preprocessing. They are also known as shift invariant or space invariant artificial neural networks (SIANN), based on their shared-weights architecture and translation invariance characteristics.

LeNet-5 is often considered as the first CNN that worked in practice for tasks of character recognition in pictures. The design of CNN exploits the space and this is what it is desired for beyond-illumination applications as the ones above in which a number of sensors are deployed in a given Region of Interest to monitor a Feature of Interest, e.g., a landslide or the number of people in a room. For instance, if a landslide occurs, the “data pattern” captured by the sensors will be independent of the location of the landslide itself.

The main features of the operation of a CNN when doing classification are as follows.
N-times (N-Layers)
A convolutional layer computes the convolution of the input data with a convolution filter (called a “weighting window”). This convolution will perform over the whole input data, typically an array or matrix, so that the convolution highlights specific patterns. This has three main implications: (i) only local connectivity is required (of the size of the filter) between the input and output nodes of the CNN, (ii) it shows the spatial arrangement of the data in the sense data relevant for the filter is originated from closely located regions in the input (vector/matrix); (iii) it shows that parameters of the filter can be shared—this means that the input is time/space invariant.
A subsampling or pooling layer extracts the most important features after each convolution. The main idea is that after the convolution, some features might arise in closely located areas. Redundant information can be then removed by sub-sampling. In general, the output of the convolution is divided into a grid (e.g., cells of side 2×2) and a single value is output from each cell, e.g., the average or the maximum value.
A Rectified Linear Unit (ReLU) layer takes the output of the subsampling area and rectifies to a value in a given range, typically, between 0 and a maximum. A way to interpret this layer is to see it as a binary decision that determines whether in a given area (after convolution and subsampling) a given feature has been determined or not at all. A ReLU layer can be implemented by means of sigmoid function f(x)=(1+e^{-x})⁻¹, i.e., if x is very small, then f(x) is 0, if x is around ½, if x is large, the f(x) tends to 1.

The above structure of convolutional/subsampling and ReLU layers is applied a number of N times obtaining some output data out of the input data. In general, if the subsampling layer has a size of 2×2, then the size of the features will have size n*2^{-N} for an input data space of size n² and N layers.

A fully connected layer is the last layer that connects all outputs of the previous layer to obtain the final answer as a combination of the features of layer N−1. This layer can be as easy as a matrix operation times the input generated by the last layer to quantify the likelihood of each of the potential events/classes.

The process to learn the parameters of a CNN is summarized as follows:
Initialize all parameters (weights and biases) in a random way.
Compute the outputs for training data.
Compute the cost function (error) in the last layer (C=½Σ(target−output)²)
Backpropagate the error, and derive the error in each of the neurons within the network.
Given the error in the each of the neuros in the network, obtain the gradient of the cost function with respect to the weight and the bias.
Update the updated values of weight and bias as wᵢ₊₁=wᵢ−ηdC/dW where wᵢ is a weight in the current iteration, η is the learning rate, and dC/dW is the computed gradient.

There are two main problems/shortcomings with the prior art system. The first problem with the prior art is that it is unknown how deep learning can be applied in practice to smart Lighting applications in which each luminaire includes a small sensor generating triggers about a specific feature in the environment. The second problem is the fact that existing (deep learning) methods require sending all data from the sensors to the cloud so that all the data is processed. This is inefficient from a bandwidth point of view.

Cloud computing is an information technology (IT) paradigm that enables ubiquitous access to shared pools of configurable system resources and higher-level services which can be rapidly provisioned with minimal management effort, often over the Internet. Cloud computing relies on sharing of resources to achieve coherence and economy of scale, similar to a utility. However, cloud computing alone is not enough for solving the aforementioned shortcomings: smart networks such as lighting networks are often bandwidth constrained, and cannot afford to send all the raw data to the remote cloud. Moreover, running the entire deep learning algorithm on the cloud is not efficient.

Aspects and embodiments of the present invention address one and/or both of these shortcomings.

### SUMMARY OF THE INVENTION

One aspect of the present invention related to an improved method using deep learning based on convolutional neural networks can be applied to IoT networks. This method uses data obtained by a network of the sensors so that events can be detected with higher reliability.

Another aspect of the present invention relates to a method to use a CNN model that can be divided and run partially in an IoT network and partially in the cloud. This allows for savings in bandwidth. The cloud can automate the computation of the nodes in the IoT network with different roles (sensing and aggregating) and how the model can be divided and deployed.

Yet another aspect of the present invention relates optimizing the bandwidth utilization in an IoT network and the cloud.

Yet another aspect of the present invention enables real-time applications that depend on deep learning networks. This can be used to ensure that a gateway or other intermediate infrastructure which is part an IoT network or a cloud computing network does not get overwhelmed with handling incoming data and performing deep learning operations.

One embodiment of the present invention is directed to a computer-implemented method for a plurality of nodes using ML learning in an IoT network. The method includes the steps of obtaining a trained ML model, physical location data of the plurality of nodes and communication connectivity data of the nodes. A clustering algorithm is used to determine which of nodes should be sensing nodes and which should be aggregating nodes. The sensing nodes sense and send sensed data to the aggregating node. The aggregating node functionality includes one or more of the following actions: (i) sensing, (ii) receiving the sensed data from the sensing node, (iii) performing convolution of the sensed data received from the sensing node with a weighed window, (iv) applying a sigmoid function to the convolution output, (v) sub-sampling the convolution output, (vi) sending a message to an ML unit part of a cloud computing network containing a result of the actions. Configuration information is sent to the IoT network as to which of the plurality of nodes should be the sensing or the aggregating nodes.

One advantage of this method is to reduce latency of the IoT network.

Another embodiment of the present invention is directed to a method for improving bandwidth utilization by using a CNN model that can be divided and run partially in an IoT network including a plurality of nodes and partially in a cloud computing network including an ML unit. The method includes the step of first processing a first layer of the CNN model using the IoT network. The IoT network includes one or more aggregating nodes and a plurality of sensing nodes. The sensing nodes sense and send via a LAN interface sensed data to the aggregating node. The aggregating node functionality includes one or more of the following actions: (i) sensing, (ii) receiving the sensed data from the sensing node, (iii) performing convolution of the sensed data received from the sensing node with a weighed window; (iv) applying a sigmoid function to the convolution output, (v) sub-sampling the convolution outputs, (vi) sending a message to the ML unit containing a result of the actions. The method also includes the steps of second processing the message of the actions by the ML unit in one or more upper layers of the CNN model and determining a feature of interest (FOI) prediction based upon the first and the second processing.

Yet another embodiment of the present invention is directed to a smart lighting network a plurality of sensing nodes each including at least a first sensor and a first LAN interface and a plurality of aggregating nodes including at least a second sensor, a second LAN interface, a WAN interface and a processor. The aggregating nodes are configured to perform one or more of the following actions: (i) sensing, (ii) receiving sensed data from one or more of the sensing nodes, (iii) performing convolution of the sensed data received the one or more sensing nodes with a weighed window; (iv) applying a sigmoid function to the convolution output, (v) sub-sampling the convolution outputs, (vi) sending a message to an ML unit that is part of a cloud computing network containing a result of the actions. Determining which of the sensing nodes should send the sensed data to which of the aggregating nodes is determined according to an ML model that takes into account that the number of aggregating nodes, determined by a window size of the ML model, and bandwidth communication limitations of the smart lighting network.

### BRIEF DESCRIPTION OF THE DRAWINGS

Further details, aspects, and embodiments of the invention will be described, by way of example only, with reference to the drawings. Elements in the figures are illustrated for simplicity and clarity and have not necessarily been drawn to scale. In the Figures, elements which correspond to elements already described may have the same reference numerals. In the drawings,

FIG. 1 schematically shows an example of an embodiment of system elements,

FIG. 1a schematically shows an embodiment of an outdoor lighting system,

FIG. 2 schematically shows a detail of an example of an embodiment of components in a node of the system elements of FIG. 1,

FIG. 3 schematically shows an example of an embodiment of centralized operation of the system elements of FIG. 1,

FIG. 4 schematically shows an example of an embodiment of distribution of a first layer of a CNN to an IoT network,

FIG. 5 schematically shows an example of a number local communications in 2×2 and 3×3 convolution windows,

FIG. 6 schematically shows an example of an embodiment of a number of windows and aggregator nodes,

FIG. 7 schematically shows an example of a method to optimize the way an ML model is deployed in an IoT network,

FIG. 8 shows an example of a spatial window function that may be used to distribute the nodes of the system elements of FIG. 1.

### DETAILED DESCRIPTION OF PREFERRED EMBODIMENTS

While this invention is susceptible of embodiment in many different forms, there are shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described herein or recited in mutually different dependent claims.

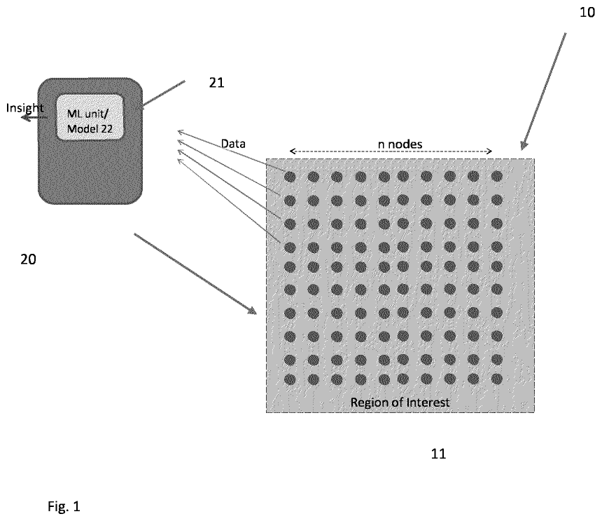

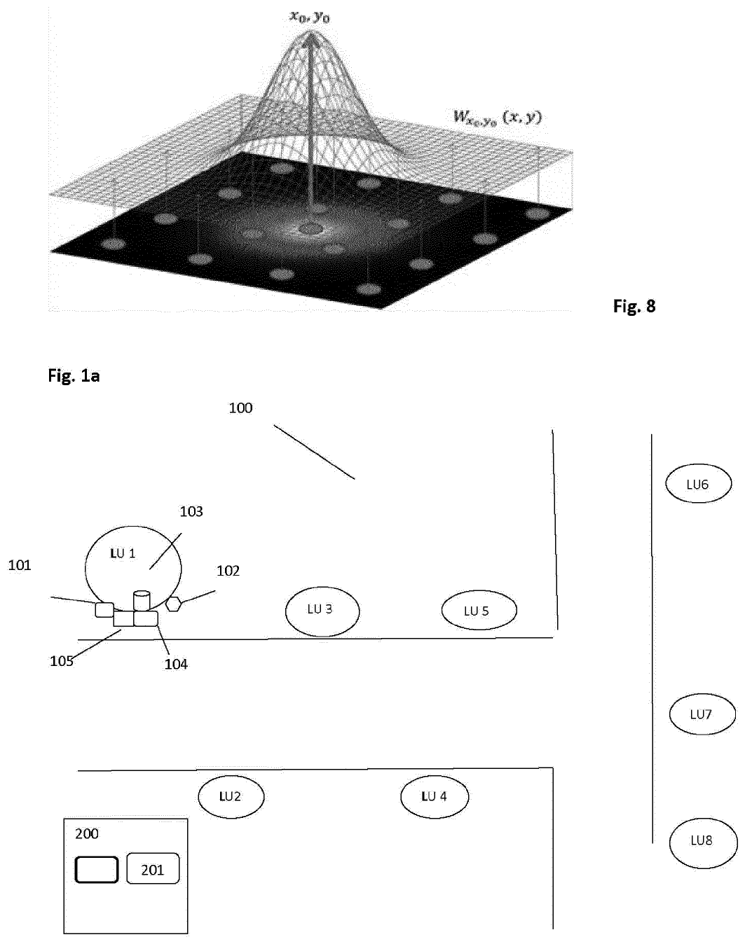

FIG. 1 shows a representation of system elements according to one embodiment of the present invention. As shown in FIG. 1, n nodes 10 are deployed in a region of interest (ROI) 11. The nodes 10 monitor a feature of interest (FOI) in the ROI 11. As noted above, the FOI maybe, for example, occupancy, soil movement or any other characteristic or variable in the ROI. In one embodiment, the FOI is an occupancy metric, e.g., a people count or a people density, for the ROI. The FOI may be obtained through some means outside of the regular organization of the lighting system. For example, cameras may be used to count people, or people may be on the floor to count people. People may be tagged, e.g., through their mobile phone to detect their presence.

The nodes 10 collect data that is then sent (potentially after some degree of pre-processing) to a cloud 20 (or cloud computing network) where a machine learning (ML) unit 21 which contains algorithms that processes data from the nodes 10 to obtain a given insight regarding the FOI. The processing is done according to a trained ML model 22. The process of training an ML model involves providing an ML algorithm (that is, the learning algorithm) with training data to learn from. The training data must contain the correct answer, which is known as a target or target attribute. The learning algorithm finds patterns in the training data that map the input data attributes to the target (the answer to be predicted), and it outputs the trained ML model 22 that captures these patterns. The trained ML model 22 can be used to obtain predictions on new data for which the target is unknown.

FIG. 1a shows another configuration of an outdoor lighting system according to an embodiment of the invention.

As shown in FIG. 1a, an outdoor lighting system 100 includes one or more lighting units (LU1-LU8) which are configured to act as the nodes 10. The LUs (LU1-LU8) may include a light producing mechanism 101, one or more sensors 102, a database 103, a communication interface 104 and a light level controller 105.

The sensor 102 may be used to detect one or more objects/features (FOI) within a predetermined sensing range (ROI). The sensor 102 may be any suitable sensor to achieve this result. For example, passive infrared, radar sensors, GPS or cameras can be used to give out detection results. Such sensors 102 may send a “detection” in the form of a sensed data result if an object or feature is detected within the sensing range of the sensor 102. The sensor 102 may also periodically attempt to detect objects within the sensing range and if an object is detected, a “detect” results, or else a “no detection” results.

The communication interface 104 may be, for example, a hardwired link and/or a wireless interface compatible with DSRC, 3G, LTE, WiFi, RFID, wireless mess or another type of wireless communication system and/or a visual light communication. The communication interface 104 may be any suitable communication arrangement to transfer data between one or more of the LUs (1-8), a control unit 200 and/or the cloud 20.

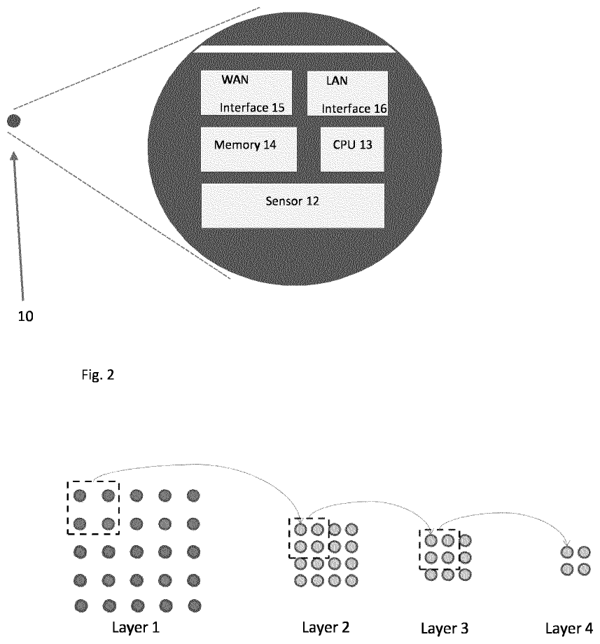

The database 103 need not be included in the LUs (1-8). Since the LUs (1-8) can communicate with one or more other LUs (1-8) and/or an intermediate node (not shown in FIG. 2a), any data that would need to be stored or accessed by a particular LU (LU1-LU8) can be stored in and accessed from the database 103 in another LU (LU1-LU8), in the intermediate node, or other network storage as needed.

As shown in FIG. 1a, the lighting system 100 may also include the control unit 200 (e.g., a service center, back office, maintenance center, etc.). The control unit 200 may be located near or at a remote location from the LUs (LU1-LU8). The central control unit 200 includes a communication unit 201 and may also include a database 202. The communication unit 201 is used to communicate with the LUs (LU1-LU8) and/or other external networks such as the cloud 20 (not shown in FIG. 1a). The control unit 200 is communicatively coupled to the LUs (LU1-LU8) and/or the cloud 20, either directly or indirectly. For example, the control unit 200 may be in direct communication via a wired and/or wireless/wireless-mesh connection or an indirect communication via a network such as the Internet, Intranet, a wide area network (WAN), a metropolitan area network (MAN), a local area network (LAN), a terrestrial broadcast system, a cable network, a satellite network, a wireless network, power line or a telephone network (POTS), as well as portions or combinations of these and other types of networks.

The control unit 200 includes algorithms for operating, invoking on/off time and sequencing, dimming time and percentage, and other control functions. The control unit 200 may also perform data logging of parameters such as run-hours or energy use, alarming and scheduling functions.

The communication interface 104, as noted above in relation to the communication unit 201, may be any suitable communication arrangement to transfer data to and/or from the control unit 200. In this regard, via the communication interface 104, each LU (LU1-LU8) maybe in communication, as may be needed, with the control unit 200 directly and/or via another LU (LU1-LU8). The communication interface 104 enables remote command, control, and monitoring of the LUs (LU1-LU8).

The sensors 102 deployed throughout the lighting system 100 capture data. This data may be related to a variety of features, objects, characteristics (FOI) within range of the sensors 102. Raw data and/or pre-processed data (referred to as “data”) maybe transmitted to the control unit 200, the cloud 20 or other network device for processing as discussed below.

It should be understood that the embodiments of FIGS. 1 and/or 1a can be deployed (or modified to be deployed) in a building, e.g., an office building, a hospital and the like. A connected lighting system is not necessary for embodiments, for example, sensors and the like may be installed without or distinct from a connected lighting system. However, the inventors found that the infrastructure of a connected lighting system lends itself well to install an embodiment of the invention upon.

FIG. 2 shows another embodiment's system components of the node 10. In this embodiment, the node 10 includes at least a sensor 12 (e.g., a PIR sensor, a GPS sensor, or an accelerometer, etc.). In other embodiments, FOI may include (1) instant features that show the instant output of the sensor 12 at the time the data is queried, including, e.g., light level, binary motion, CO2 concentration, temperature, humidity, binary PIR, and door status (open/close); (2) count features that register the number of times the sensor's 12 output changes in the last minute, (motion count net, PIR count net, and door count net); (3) average features that show average value of the sensor's 12 output over a certain period of time (occupancy sensors, sound average, e.g., every 5 seconds).

The data from the sensor 12 may be processed by a CPU 13 and/or stored in local memory 14. The node 10 can then send the information to, for example, other nodes 10 in a local area network (LAN) using a LAN interface 16, the control unit 200 and/or to the cloud 20 over the Wide Area network (WAN) using a WAN interface 15.

In other embodiments, some of the communication interfaces noted above between the nodes 10, the cloud 20 and the control unit 200 may comprise a wired interface such an Ethernet cable, or a wireless interface such as a Wi-Fi or ZigBee interface, etc.

The nodes 10 in FIGS. 1, 1a and 2 may be IoT (Internet of Things) devices. IoT refers to the ever-growing network of physical objects that feature an IP address for internet connectivity, and the communication that occurs between these objects and other Internet-enabled devices and systems. IoT is the network of physical devices, vehicles, home appliances, and other items embedded with electronics, software, sensors, actuators, and network connectivity which enable these objects to connect and exchange data. Each thing is uniquely identifiable through its embedded computing system but is able to inter-operate within the existing Internet infrastructure.

The IoT allows objects to be sensed or controlled remotely across existing network infrastructure, creating opportunities for more direct integration of the physical world into computer-based systems, and resulting in improved efficiency, accuracy and economic benefit in addition to reduced human intervention. When IoT is augmented with sensors and actuators, the technology becomes an instance of the more general class of cyber-physical systems, which also encompasses technologies such as smart grids, virtual power plants, smart homes, intelligent transportation and smart cities.

The nodes 10 (i.e., an IoT device) may process raw data from the sensor 12 or may offload or share the processing of the raw data with a remote device such as the cloud 20.

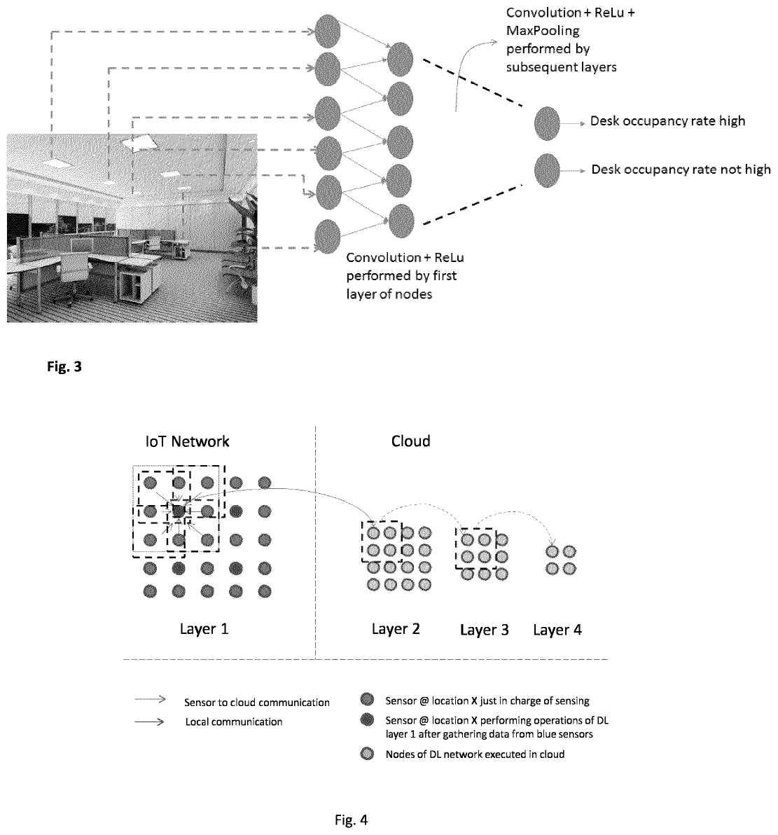

Before describing how the processing functionality can be divided between the cloud 20 and within the nodes 10 and/or the control unit 200, first is described how a CNN network can be applied centrally in the cloud 20. In this regard, FIG. 3 depicts a multi-layer architecture in which the first layer corresponds to the nodes 10 (shown as lighting units in the ceiling) deployed in the ROI (See FIG. 1). FIG. 3 shows an example in an office setting where the occupancy rate is to be determined. In this case, in layer 1 corresponds to the output of one node 10 at a given instant of time T. The particular filter depicted in FIG. 3 has a given dimension representing a given spatial area that is to be scanned. It should be understood that other dimensions may be used. The convolution of this filter with that values of the input data is used to obtain a value for layer 2 (which is then used for subsequent layers, etc.) after applying an ReLU function. The convolution is performed using a weighting window. It is also noted that the above description does not include the sub-sampling phase, however, this phase can be included as well.

Now that the above description of a centralized system has been described, how the processing functionality can be divided between the cloud 20 and the nodes 10 and/or the control unit 200 (i.e., an IoT network) is described. This is depicted in FIG. 4. Here, the first layer of the CNN can be deployed to the IoT network so that the operations corresponding to that layer are executed locally (i.e., in the nodes 10 and/or the control unit 200).

Two types of nodes 10 are identified: sensing nodes and aggregating nodes. Sensing nodes' functionality is limited to sensing and sending the sensed values (as it was the case in the previous explained centralized embodiment) to aggregating nodes. Aggregating nodes' functionality includes one or several of the following actions: (i) sensing; (ii) receiving sensed values from closely located nodes 10; (iii) performing the convolution of data received from closely located nodes with the weighed window; (iv) applying the sigmoid function to the convolution output; (v) sub-sampling the outputs; (vi) sending a message towards the cloud containing each of the values after steps (iii), (iv), and (iv).

The input received by the cloud from the aggregating nodes 10 are the input to the upper layers of the CNN. In this example, it will be the input to Layer 2.

The communication between the sensing nodes 10 and the aggregating nodes 10 may take place by using the LAN interface 16. The communication between the aggregating node 10 and the cloud 12 may use the LAN interface 16 to reach a gateway (not shown) that includes its own WAN network interface or alternatively directly over the WAN interface 15.

The process of deploying ML parameters to the nodes 10 and/or the control unit 200 (i.e., the IoT Network) as part of the software-defined deep learning is now described. As noted above, once the trained ML model 22 has been learned, the cloud 20 will have a pattern of the IoT network (in general, deep learning algorithm or machine learning algorithm). At this stage, the cloud 20 has to optimize the way the trained ML model 22 is deployed to the IoT network to obtain maximum performance.

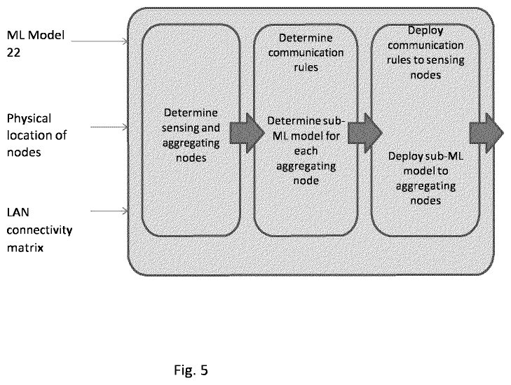

The overall process is depicted in FIG. 5. As inputs, the process receives the trained ML model 22, the physical location of the nodes 10 (e.g., the GPS coordinates of nodes places outdoors, or the layout of nodes 10 in a building), and the LAN connectivity matrix of the nodes 10 (i.e., how the nodes can communicate with each other—this can include signal strength at Phy layer, packet throughput at MAC layer, routing structure, etc.).

Given these inputs, the ML unit 21 will determine the appropriate sensing nodes 10 and the aggregating nodes 10. This step can be done using a clustering algorithm. Clustering is the task of dividing the population or data points into a number of groups such that data points in the same groups are more similar to other data points in the same group than those in other groups. The aim is to segregate groups with similar traits and assign them into clusters. There are many types of clustering algorithms such as connectivity models, centroid models, distribution models and density models as well as types of clustering such as k-means and hierarchical.

In one embodiment of the present invention, a k-means clustering algorithm is used that takes into account that the number of aggregating nodes 10 is well determined by the window size of the ML model 22 and the overall communication limitations (amount of bytes and messages that can be sent from the network of nodes 10 to the cloud 20). Given the initial number of aggregating nodes 10, the nodes 10 can then be placed according to a given grid and the use data regarding the physical location and LAN connectivity to determine the set of nodes 10 that minimize local communication and maximize performance.

Once the aggregating nodes 10 are determined, then the ML unit 21 will determine which sensing nodes 10 should send its data to which aggregating nodes 10. Alternatively, ML unit 21 may determine to which sensing nodes 10 an aggregating node 10 should subscribe to receive their data. This is determined in such a way that an aggregating node 10 receives all data generated by surrounding nodes 10 and required to generate the input data to the next layer (sub-sampling included). Furthermore, the ML unit 21 will determine the operations that each aggregating node 10 needs to realize with the gathered data (typically: convolution, sigmoid function, subsampling) and then the logic for the sending of a message towards the cloud 20.

The final step is sending a message to each of the nodes 10 in the network with the specific configuration: sensing or aggregating node 10; how sensed information should be distributed; sub-ML model in aggregating nodes 10. There may also be some handshaking in the communication to ensure that the cloud 20 information has been correctly received by the nodes 10 (reliability).

The advantages and disadvantages of the centralized and distributed deep learning processing approaches described above are now compared. In this regard, three different configurations of a distributed architecture are described:

(1) where the first CNN layer runs in the IoT network and with a weighting window of size 2×2,

(2) where the first CNN layer runs in the IoT network and with a weighting window of size w×w, and

(3) where the first two CNN layers run in the IoT network and with a weighting window of size 2×2.

It is noted that the computations do not include a sub-sampling effect, but just a similar reduction due to the window size similarly as shown in the above pictures.

The performance analysis is analyzed considering (1) communication overhead from node to cloud, (2) local communication requirements and (3) deep learning iterations in the IoT Network.

The following is an analysis framework to estimate the bandwidth savings that will be realized by aspects and embodiments of the present invention. Given a mesh network of luminaires (as shown in FIG. 1), the local communication over one hop can be generalized to any number of hops in the analysis framework.

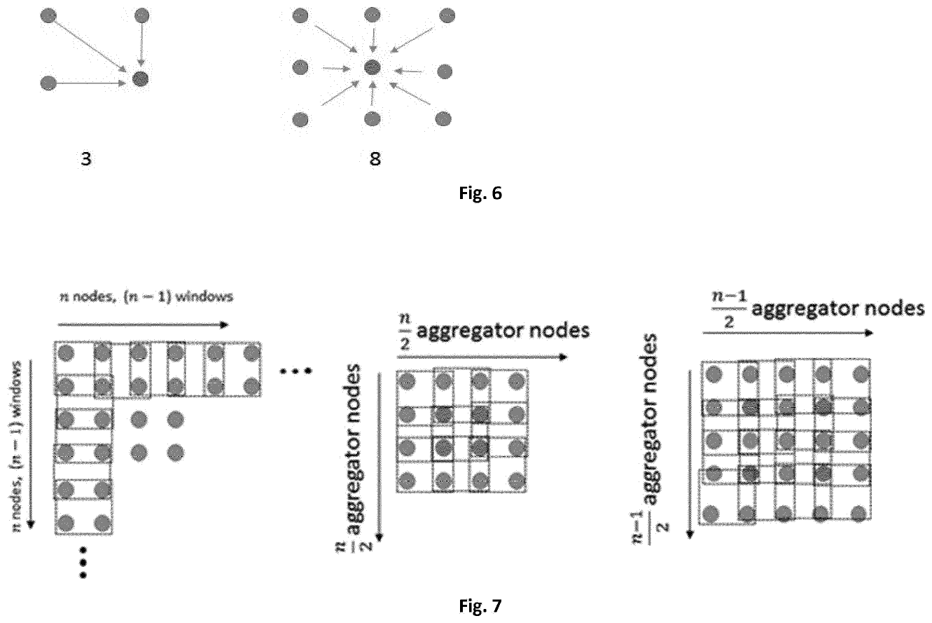

Convolution windows of sizes 2×2 and 3×3 can be handled by purely local communication. FIG. 6 shows the number of local communication messages that need to be exchanged to compute the coevolution over such windows. That is, three in the case of 2×2 nodes 10 and eight in the case of 3×3 nodes 10. For an n×n grid of nodes 10 (e.g., luminaries in the outdoor lighting system 100), the number of 2×2 convolution windows is given by (n−1)².

Next, the number of aggregator nodes 10 for an n×n grid of nodes 10 is considered. This depends on whether the n is odd or even. If n is odd, then the number of aggregator nodes 10 is given by ((n−1)/2)² and if n is even, then the number of aggregator nodes is given by (n/2)².

See FIG. 7(6) for an example of calculating the number of convolution windows and aggregator nodes 10. The total number of local communication messages is less than or equal to (w2−1)×number of windows. The total number of aggregator nodes 10 to gateway messages is equal to the number of aggregator nodes 10×the number of windows (each window produces one value). At most, four windows are handled by one aggregator node 10 for a 2×2 window.

As shown by the embodiment described above, moving functionality to the IoT network (e.g., the nodes 10 and/or the outdoor lighting system 100) introduces a significant decrease in the communication from the IoT network to the cloud 20 since the first layer(s) are executed in the IoT network extracting already higher level features. While this comes at an increased price in the local communications, however, since it is local, this does not involve a high cost as long as the nodes 10 include a LAN network interface 16. Utilizing these aspects of the present invention, some of the processing of the raw data from the sensors 12 can be easily distributed and processed in the aggregator nodes 10 and/or the control unit 200. This means that fewer computations need to be done centrally or in the cloud 20.

In another embodiment, the weights of the weighting window, the convolution filter, maybe defined by a function Wxₒ,yₒ (x, y) (spatial window) where (xₒ, yₒ) determines where the function is sampled and (x, y) determines the weight applied to the output of a sensor located a location (x, y) respect to (xₒ, yₒ). One example of such the function Wxₒ,yₒ (x, y) is shown in FIG. 8. For example, this embodiment is advantageous in smart lighting networks where the ML algorithm requires sensor data at a location where a luminaire is not located. In such a case, values from the closest luminaires can be used to interpolate the values at the desired point.

This step can be combined with the CNN sub-sampling step by considering that above spatial window is run over the input data generated by the sensors 12 and only a few output values are obtained at some locations (xₒ, yₒ) that will correspond to the inputs to the second layer in the CNN. Such a function is very useful since the sensors 12 in the nodes 10 (e.g., part of an LU) may not be distributed in practice according to a fully regular grid.

In another embodiment, the input for Layer 1 can be obtained by outputting a value from the sensors 21 computed over a period of time equal to: the addition, the maximum value, the average value. This means that a first layer of a CNN network need not work only on raw sensor data. The nodes 10 may also work with aggregate values, like the average, maximum, minimum, etc.

In another embodiment related to gun-shot detection, the node 10 may run the first layer of a CNN by performing convolution with a time-window. In this regard, the node 10 includes a sensor that is a microphone, the first layer corresponds to a convolution with the signal form of the gun-shot trigger.
In yet another embodiment, the initial weights of the weighting windows are pre-initialized according to a given ML model tailored to the signals that are to be computed. In more detail, the above embodiments have covered deploying the model across the nodes 10, and then executing the ML model using the aggregator nodes 10 and the sensing nodes 10. This embodiment is a process that precedes both these steps: learning the optimal parameters of the ML model. In this embodiment, the data is used to learn the ML model itself across the nodes 10 is determined. More specifically, initial seed-values for the iterative learning process is generated.

In the various embodiments, the input/communication interface may be selected from various alternatives. For example, an input interface may be a network interface to a local or wide area network, e.g., the Internet, a storage interface to an internal or external data storage, a keyboard, etc.

A storage or memory may be implemented as an electronic memory, a flash memory, or magnetic memory, hard disk or the like. The storage may comprise multiple discrete memories together making up the storage. The storage may also be a temporary memory, say a RAM. In the case of a temporary storage.

Typically, the cloud 12, the nodes 10, the control unit 200 each comprise a microprocessor, CPU or processor circuit which executes appropriate software stored therein; for example, that software may have been downloaded and/or stored in a corresponding memory, e.g., a volatile memory such as RAM or a non-volatile memory such as Flash (not separately shown). Alternatively, such devices may, in whole or in part, be implemented in programmable logic, e.g., as field-programmable gate array (FPGA) or may be implemented, in whole or in part, as a so-called application-specific integrated circuit (ASIC), i.e. an integrated circuit (IC) customized for their particular use. For example, the circuits may be implemented in CMOS, e.g., using a hardware description language such as Verilog, VHDL etc. The processor circuit may be implemented in a distributed fashion, e.g., as multiple sub-processor circuits. A storage may be distributed over multiple distributed sub-storages. Part or all of the memory may be an electronic memory, magnetic memory, etc. For example, the storage may have volatile and a non-volatile part. Part of the storage may be read-only.

In one embodiment, the outdoor lighting system 100 may include the sensors 102 with different modalities. The outdoor lighting system 100 may have hierarchical levels, e.g., a hierarchical structure in which devices communicate with the corresponding higher or lower level devices. Note that in a lighting system, multiple luminaires and sensors are grouped together in a control zone. Multiple control zones may be defined within the same room, e.g. one control zones for luminaires close to the window and one for the rest. Next, multiple rooms are located within the same floor and so on. At each hierarchical level, there is a local controller. A local controller may play the role as controller for multiple hierarchical levels.

Many different ways of executing the methods described above are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method.

A method according to the invention may be executed using software, which comprises instructions for causing a processor system to perform the methods. Software may only include those steps taken by a particular sub-entity of the system. The software may be stored in a suitable storage medium, such as a hard disk, a floppy, a memory, an optical disc, etc. The software may be sent as a signal along a wire, or wireless, or using a data network, e.g., the Internet. The software may be made available for download and/or for remote usage on a server. A method according to the invention may be executed using a bitstream arranged to configure programmable logic, e.g., a field-programmable gate array (FPGA), to perform the method.

It will be appreciated that the invention also extends to computer programs, particularly computer programs on or in a carrier, adapted for putting the invention into practice. The program may be in the form of source code, object code, a code intermediate source, and object code such as partially compiled form, or in any other form suitable for use in the implementation of the method according to the invention. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth.

For example, a computer readable medium having a writable part comprising a computer program, the computer program comprising instructions for causing a processor system to perform a method of the present invention according to an embodiment. The computer program may be embodied on the computer readable medium as physical marks or by means of magnetization of the computer readable medium. However, any other suitable embodiment is conceivable as well. Furthermore, it will be appreciated that, although the computer readable medium maybe an optical disc, the computer readable medium may be any suitable computer readable medium, such as a hard disk, solid state memory, flash memory, etc., and may be non-recordable or recordable. The computer program comprises instructions for causing a processor system to perform the method.

For example, in an embodiment, the nodes 10, the control unit 200 and/or the cloud 20 may comprise a processor circuit and a memory circuit, the processor being arranged to execute software stored in the memory circuit. For example, the processor circuit may be an Intel Core i7 processor, ARM Cortex-R8, etc. The memory circuit may be an ROM circuit, or a non-volatile memory, e.g., a flash memory. The memory circuit may be a volatile memory, e.g., an SRAM memory. In the latter case, the verification device may comprise a non-volatile software interface, e.g., a hard drive, a network interface, etc., arranged for providing the software.

The foregoing detailed description has set forth a few of the many forms that the invention can take. The above examples are merely illustrative of several possible embodiments of various aspects of the present invention, wherein equivalent alterations and/or modifications will occur to others skilled in the art upon reading and understanding of the present invention and the annexed drawings. In particular, regard to the various functions performed by the above described components (devices, systems, and the like), the terms (including a reference to a “means”) used to describe such components are intended to correspond, unless otherwise indicated to any component, such as hardware or combinations thereof, which performs the specified function of the described component (i.e., that is functionally equivalent), even though not structurally equivalent to the disclosed structure which performs the function in the illustrated implementations of the disclosure.

The principles of the present invention are implemented as any combination of hardware, firmware and software. Moreover, the software is preferably implemented as an application program tangibly embodied on a program storage unit or computer readable storage medium consisting of parts, or of certain devices and/or a combination of devices. The application program may be uploaded to, and executed by, a machine comprising any suitable architecture. The computer platform may also include an operating system and microinstruction code. The various processes and functions described herein may be either part of the microinstruction code or part of the application program, or any combination thereof, which may be executed by a CPU, whether or not such computer or processor is explicitly shown. In addition, various other peripheral units may be connected to the computer platform such as an additional data storage unit and a printing unit.

Although a particular feature of the present invention may have been illustrated and/or described with respect to only one of several implementations, such feature may be combined with one or more other features of the other implementations as may be desired and advantageous for any given or particular application. Furthermore, references to singular components or items are intended, unless otherwise specified, to encompass two or more such components or items. Also, to the extent that the terms “including”, “includes”, “having”, “has”, “with”, or variants thereof are used in the detailed description and/or in the claims, such terms are intended to be inclusive in a manner similar to the term “comprising”.

The present invention has been described with reference to the preferred embodiments. However, modifications and alterations will occur to others upon reading and understanding the preceding detailed description. It is intended that the present invention be construed as including all such modifications and alterations. It is only the claims, including all equivalents that are intended to define the scope of the present invention.

In the claims references in parentheses refer to reference signs in drawings of exemplifying embodiments or to formulas of embodiments, thus increasing the intelligibility of the claim. These references shall not be construed as limiting the claim.

1. A computer-implemented method for a plurality of nodes using ML learning in an IoT network, comprising the steps of:
receiving trained ML model, physical location data of the plurality of nodes and communication connectivity data of the nodes;
using a clustering algorithm, determining which of the plurality of nodes should be sensing nodes and which should be aggregating nodes, wherein sensing nodes sense and send a sensed data to one of the aggregating nodes, and the aggregating nodes having functionality that include one or more of the following actions: sensing, receiving the sensed data from the sensing node, performing convolution of the sensed data received from the sensing node with a weighed window, applying a sigmoid function to output of the convolution, sub-sampling the convolution output, sending a message to an ML unit part of a cloud computing network containing a result of the actions; and
sending configuration information to the IoT network as to which of the plurality of nodes should be the sensing or the aggregating nodes.

2. The method of claim 1, further comprising the step of the ML unit determining a plurality of operations that each of the aggregating nodes 10 needs to realize with the sensed data and logic for sending of the message towards the ML unit.

3. The method of claim 1, wherein the sensed data is either an occupancy metric for a region of interest 11 or a soil movement metric for a region of interest 11.

4. The method of claim 1, wherein the sensing nodes send the sensed data to the aggregating node using a local area network interface and the aggregating nodes send the message to the ML unit using a wide area network interface.

5. The method of claim 1, wherein the aggregating nodes send the message to the ML unit via a control unit part of the IoT network.

6. A method for improving bandwidth utilization by using a CNN model that is divided and run partially in an IoT network including a plurality of nodes and partially in a cloud computing network including an ML unit, comprising the steps of:
first processing a first layer of the CNN model using the IoT network, wherein the IoT network includes one or more aggregating nodes and a plurality of sensing nodes, where the plurality of sensing nodes sense and send via a LAN interface a sensed data to the aggregating node, and the aggregating node having functionality that includes one or more of the following actions: sensing, receiving the sensed data from the sensing node, performing convolution of the sensed data received from the sensing node with a weighed window; applying a sigmoid function to the convolution output, sub-sampling the convolution outputs, sending a message to the ML unit containing a result of the actions;
second processing the message of the actions by the ML unit in one or more upper layers of the CNN model; and
determining a feature of interest prediction based upon the first and the second processing.

7. The method of claim 6, wherein the sensed data is either an occupancy metric for a region of interest or a soil movement metric for a region of interest.

8. (canceled)

9. The method of claim 6, wherein the sensing nodes send the sensed data to the aggregating node using a local area network interface and the aggregating nodes send the message to the ML unit using a wide area network interface.

10. The method of claim 6, wherein the aggregating nodes send the message to the ML unit via a control unit part of the IoT network.

11. The method of claim 6, wherein the first processing step is performed using the aggregating node 10 which performs the first layer of the CNN model by performing convolution with a time-window.

12. The method of claim 6, wherein the first processing step is performed using the aggregating node 10 which performs the first layer of the CNN model with an initial weight of the weighting window are pre-initialized according to a given model tailored to the result of the actions that are to be determined.

13. The method of claim 6, wherein the first processing step is performed using the aggregating node 10 which performs the first layer of the CNN model by a temporal layer convoluting over the sensed data in a given time-space window.

14. A smart lighting network, comprising:
a plurality of sensing nodes each including at least a first sensor and a first LAN interface; and
a plurality of aggregating nodes each including at least a second sensor, a second LAN interface, a WAN interface and a processor, where the aggregating nodes are configured to perform one or more of the following actions: sensing, receiving sensed data from one or more of the sensing nodes, performing convolution of the sensed data received from the one or more sensing nodes with a weighed window; applying a sigmoid function to the convolution output, sub-sampling the convolution outputs, sending a message to an ML unit that is part of a cloud computing network containing a result of the actions,
wherein a determination regarding which of the plurality of sensing nodes should send the sensed data to which of the plurality of aggregating nodes is determined according to an ML model that takes into account that the number of aggregating nodes, determined by a window size of the ML model 22, and bandwidth communication limitations of the smart lighting network.

15. The smart lighting network of claim 14, wherein the sensing nodes send the sensed data to the aggregating node using the first LAN interface and the aggregating nodes send the message to the ML unit using the WAN interface.
